(19) United States
(12) Patent Application Publication
(10) Pub. No.: US 2012/0148764 A1
(43) Pub. Date: Jun. 14, 2012

(54) DEPOSITION OF THERMOELECTRIC MATERIALS BY PRINTING

(75) Inventors: Christelle NAVONE, Saint Jean de Moirans (FR); Mathieu SOULIER, Grenoble (FR)

(73) Assignee: COMMISSARIAT A L'ENERGIE ATOMIQUE ET AUX ENERGIES ALTERNATIVES, Paris (FR)

(21) Appl. No.: 13/323,296

(22) Filed: Dec. 12, 2011

(30) Foreign Application Priority Data
Dec. 10, 2010 (FR) 1004815

(51) Int. Cl. B05D 5/12; B06B 1/20

(52) U.S. Cl. 427/600; 427/58

(57) ABSTRACT

A method for producing a layer of thermoelectric material with a thickness comprised between 50 μm and 500 μm on a substrate comprises preparing an ink comprising the thermoelectric material, a solvent and a binding polymer material, depositing a layer of ink on a substrate, heating the layer of ink to evaporate the solvent, compressing the layer and performing heat treatment to eliminate the binding polymer material. Deposition of the layer of ink is performed by pressurized spraying under conditions such that the solvent is partially evaporated before reaching the substrate.

### BACKGROUND OF THE INVENTION

The invention relates to the production of thermoelectric modules, and more particularly to deposition of layers of thermoelectric material by printing.

### STATE OF THE ART

A thermoelectric module comprises several thermoelectric elements, also called thermoelements, electrically connected in series and thermally connected in parallel. The performances of such a module depend on the thermoelectric materials used and on the geometry of the module.

Thermoelectric materials having a high figure of merit ZT at the operating temperature of the module are generally chosen. The figure of merit is written:

$$ZT = \frac{σ \cdot {S}^{2}}{λ} T ,$$

where σ is the electrical conductivity, S is the Seebeck coefficient, λ the thermal conductivity and T the temperature. The product σ·S² is called power factor.

A material with good thermoelectric properties therefore presents high electrical conductivity and Seebeck coefficient and a low thermal conductivity. At ambient temperature, bismuth (Bi) and tellurium (Te) based alloys are particularly interesting.

The geometry of the module is optimized for each application according to the environment in which the module is used, i.e. according to the thermal conditions. In particular, the optimal thickness of the thermoelements depends mainly on the chosen materials, the thermal conductivity of the module and the heat flux provided by the hot source.

FIG. 1 represents the electric power generated by a module versus the thickness of its thermoelements, for a given heat flux (5 W·cm⁻²). In this example, the optimal thickness is about 300 μm. For moderate fluxes (lower than 10 W·cm⁻²), it is observed that the generated electric power is maximal for thicknesses comprised between 50 μm and 500 μm.

Several technologies exist for producing thermoelements. Formation of thermoelements can be accomplished either by thin-film deposition methods, derived from microelectronic, or bulk fabrication methods such as sintering, dicing and assembly techniques.

Thin-film deposition methods, like PVD or CVD technology, are inappropriate for forming layers with a thickness of more than 50 μm. Bulk technology requires a high level of precision and quality control to achieve thermoelements with a thickness of less than 500 μm. This technology, which is heavy to implement, then becomes difficult to apply on a large scale.

To produce thermoelements with a thickness comprised between 50 μm and 500 μm in simple and reproducible manner, printing techniques, in particular inkjet printing and screen printing, are used.

The article [Development of (Bi,Sb)₂(Te,Se)₃-Based Thermoelectric Modules by a Screen-Printing Process, Navone et al., Journal of Electronic Materials, Vol. 39, N° 9, 2010] describes production of thermoelements by screen printing.

In a first step, an ink is prepared by mixing a powder of active materials, a binding polymer and a solvent. The powder contains particles of semi-conducting materials: tellurium (Te), bismuth (Bi), antimony (Sb) and selenium (Se). The quantity of active materials represents 76% of the weight of the ink. Polystyrene is chosen as binding polymer and represents 2% of the weight of the ink. The remaining quantity corresponds to the solvent, which is toluene.

The ink is then deposited by screen printing on a flexible substrate made from polyethylene naphtalate (PEN) in legs having a thickness of 80 μm. The solvent is then evaporated by increasing the temperature to 60 ° C. for several hours. A uniaxial pressure of 50 MPa is applied on the legs to increase the cohesion of the particles and adhesion of the legs on the PEN substrate. Finally, pulsed laser annealing with a power of 473 mJ·cm⁻² is performed to eliminate the polymer thereby increasing the electrical conductivity of the thermoelements.

Large mechanical stresses are however observed in the thermoelectric layer produced by this technique. During the heat treatment steps, evaporation of the solvent and elimination of the polymer do in fact cause grain movements in the layer. Cracks may appear in the thermoelements. The thermoelements are moreover sensitive to delamination on certain substrates.

### SUMMARY OF THE INVENTION

A need exists to provide a method for producing a layer of thermoelectric material having both good mechanical properties and high thermoelectric performances.

This need tends to be satisfied by preparing an ink comprising the thermoelectric material, a solvent and a binding polymer material, by depositing a layer of ink on a substrate, heating the layer of ink to evaporate the solvent, compressing the layer and performing heat treatment to eliminate the binding polymer material. Deposition of the layer of ink is achieved by pressurized spraying under conditions such that the solvent is partially evaporated before reaching the substrate.

### BRIEF DESCRIPTION OF THE DRAWINGS

Other advantages and features will become more clearly apparent from the following description of particular embodiments given for non-restrictive example purposes only and illustrated by means of the appended drawings, in which:

FIG. 1, previously described, represents the electric power generated by a thermoelectric module versus the thickness of the thermoelements;

FIG. 2 is a flowchart illustrating a method for producing layers of thermoelectric material according to the invention; and

FIGS. 3 and 4 are respectively microscope photographs of a thermoelectric layer obtained by screen printing and of a layer obtained by the method according to the invention.

### DESCRIPTION OF A PREFERRED EMBODIMENT OF THE INVENTION

It is proposed here to limit the internal stresses due to elimination of the solvent and of the polymer material by depositing the ink by spraying. The spraying conditions are chosen such that a part of the solvent is evaporated when deposition is performed. A porous layer is then obtained, which will enable the stresses to be relaxed when final elimination of the additives takes place.

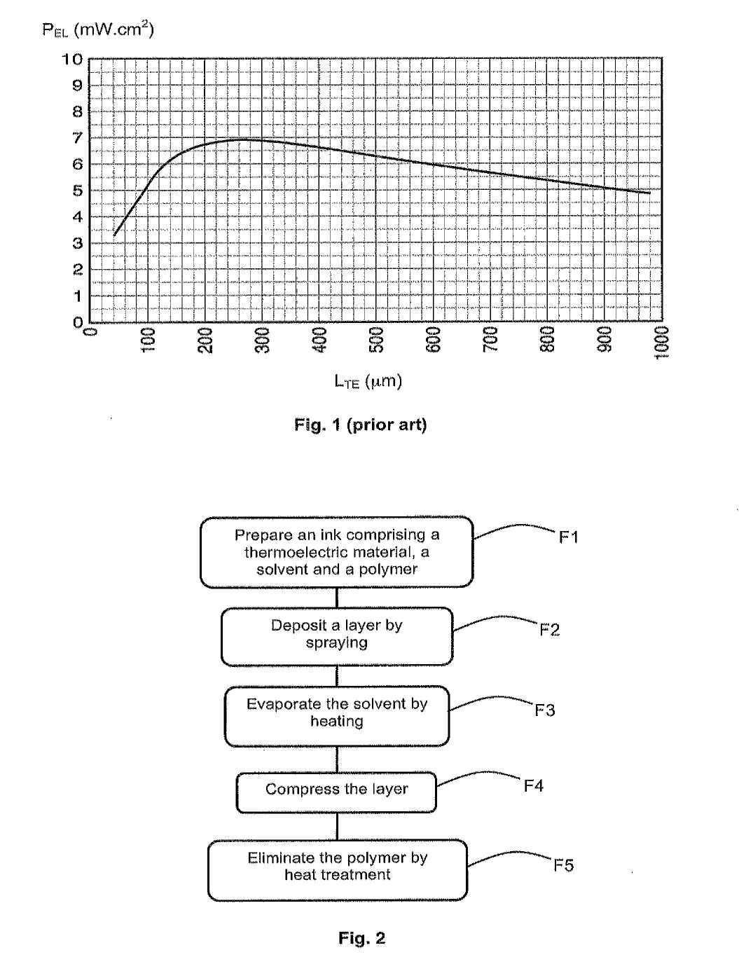

FIG. 2 represents steps of a method for producing layers of thermoelectric material with relaxed stresses, in flowchart form.

In a step F1, an ink compatible with the spray printing technique is prepared. The ink comprises a thermoelectric material designed to form the thermoelements, a polymer material and a solvent.

The thermoelectric material is preferably in the form of semi-metallic or semi-conducting particles with a diameter comprised between 10 nm and 10 μm, dispersed in the solvent. The thermoelectric material can be chosen from bismuth and tellurium alloys, for example a Bi_{0.5}Sb_{1.5}Te₃ powder for the P-type thermoelements and a Bi₂Te_{2.7}Se_{0.3} powder for the N-type thermoelements.

The solvent is chosen such that it partially evaporates when spray printing is performed, i.e. before reaching the substrate. Furthermore, a solvent having a high wettability compared with the thermoelectric material is privileged. This means that the surface tension of the solvent is greater than the surface tension of the thermoelectric material. Such a solvent is preferably chosen from toluene, polyglycol-methyl-ether acetate (PGMEA), tetrahydrofuran (THF) and dichloromethane.

The polymer material is dissolved in the solvent. It acts as a binder between the thermoelectric particles and enhances adhesion of the ink on the substrate. The polymer is preferably polystyrene.

The ink is mainly composed of thermoelectric particles. A high concentration of thermoelectric particles increases the electric conductivity of the thermoelements, which improves the figure of merit ZT. The ink on the other hand is more viscous. A large quantity of polymer enhances the cohesion of the particles but decrease the thermoelectric properties, in particular the Seebeck coefficient. The ink preferably comprises, in weight percentage, between 62% and 74% of thermoelectric material, between 1% and 3% of polymer and between 25% and 35% of solvent.

The ink can also comprise a dispersant in order to homogenize the constitution of the ink, for example the dispersant marketed under the Triton trademark by Union Carbide Corporation.

In step F2, a layer of ink with a thickness comprised between 60 μm and 1500 μm is formed on the substrate by pressurized spray deposition (PSD). Droplets are ejected from a printing nozzle in the form of a spray due to the effect of a compressed gas, inert with respect to the constituents of the ink. The viscosity of the ink, the diameter of the nozzle and the pressure of the gas determine the speed at which the droplets are ejected. The use of a mask in contact with the substrate enables patterns to be defined in the printed layer if required.

The operating conditions are chosen such that the whole of the solvent is not evaporated when spraying is performed. Indeed, when the solvent is completely evaporated, the printed layer presents a powdery aspect without any adherence on the substrate. The spraying conditions are preferably chosen so as to evaporate between 70% and 90% of the quantity of solvent.

On account of the high wettability of the solvent, the distribution of the droplets within the spray is globally homogeneous. The quality of deposition is then improved. This further prevents formation of voluminous aggregates between the particles, which would be liable to block the printing nozzle.

Spray deposition can be fully automated and ultrasonically assisted (ultrasonic spray deposition, USD). High-frequency vibrations divide the ink into finer droplets, which are then conveyed by the gas to the substrate.

The following operating parameters have enabled satisfactory results to be obtained:
nozzle-substrate distance comprised between 5 cm and 10 cm;
diameter of the nozzle larger than 40 times the size of the particles (>400 μm);
pressure of the compressed gas (nitrogen, argon or air) used for spraying comprised between 0.8*10⁵ Pa and 10⁵ Pa.

The ink is preferably heated to a temperature strictly lower than the boiling temperature of the solvent during the spraying step. Partial evaporation of the solvent can for example take place at ambient temperature in the case of toluene (boiling temperature of toluene: 110° C.). For other solvents with high boiling temperatures, it is preferable to heat the ink spray, for example between 80° C. and 100° C. in the case of PGMEA (T_{boil}=146° C.).

Heating of the ink during spraying can be performed by convection from heating of the substrate. In the case of PGMEA and a nozzle-substrate distance of 5 cm to 10 cm, the substrate can be heated to a temperature comprised between 90° C. and 120° C. For toluene, the substrate can also be slightly heated, between 20° C. and 50° C.

In a step F3, the remaining quantity of solvent is evaporated by heating. The porous structure of the layer obtained by spraying enhances final evaporation of the solvent. The grain movements are fewer, which makes the layer mechanically stronger. The heating temperature can thus be increased without risking weakening the layer. The drying temperature is preferably comprised between 90° C. and 150° C.

Because of a part of the solvent has already evaporated and due to a higher temperature, the duration of heating can be considerably reduced compared with conventional techniques. The heating duration can be a few minutes.

After the solvent has completely evaporated, the quantity of polymer represents about 2% of the dry matter and the quantity of thermoelectric materials represents about 98% of the dry matter.

This dry matter can also contain from 1% to 3% of additives for the purposes of improving the thermoelectric performances. These additives can be metallic nanoparticles, carbon nanotubes, impurities such as halogenides (AgI) or metal oxides.

In a step F4, the layer is compressed in a direction perpendicular to the substrate. The pressure preferably varies between 50 MPa and 200 MPa depending on the thickness of the layer. The highest pressures are applied to the layers of small thickness (50-100 μm).

In a step F5, heat treatment is performed to eliminate the polymer material. This heat treatment is preferably performed in an inert atmosphere at a temperature comprised between 350° C. and 400° C. in the case of bismuth and tellurium based alloys.

The compression step (F4), followed by annealing (F5) at a temperature of about 80% of the melting temperature of the thermoelectric material, corresponds to a sintering operation. It enables the density of the layer to be increased. The thermoelectric properties, in particular the electrical conductivity, are thus improved.

Due to the improved mechanical properties of the layer obtained in the foregoing steps, the sintering pressure can be increased compared with techniques of the prior art. This enables higher electrical conductivities to be achieved.

In the case of a flexible substrate, for example made from polyimide, it is generally more difficult to obtain a quality thermoelectric layer which adheres to the substrate. Indeed, the coefficient of expansion of polyimide being considerably greater than that of thereto-electric materials, the layer printed on the polyimide substrate is tension-stressed. This tension stress is lower for other types of substrate, for example made from glass (quartz), as the difference of coefficients of expansion is lesser.

The method described in the foregoing is particularly suitable for substrates made from plastic material, in particular polyimide. It guarantees adhesion of the thermoelectric layers on polyimide.

For example purposes, P-type and N-type thermoelements are produced on a flexible substrate made from polyimide using the method of FIG. 2. The P-type thermo-elements,

TABLE 2

| | Type of material | | | |
|---|---|---|---|---|
| | P-type | | N-type | |
| | Before | | Before | |
| | sintering | After sintering | sintering | After sintering |
| σ (S · m⁻¹) | 190 | 80,000 | 115 | 13,000 |
| S (μV · K⁻¹) | 164 | 74 | −99 | −224 |

with a thickness of about 60 μm, are made from Bi_{0.5}Sb_{1.5}Te₃ alloy. The sintering step of the P-type thermoelements is constituted by a uniaxial compression at 50 MPa followed by annealing at 396° C. for 6 hours under argon atmosphere. The N-type thermoelements, with a thickness of about 80 μm, made from Bi₂Te_{2.7}Se_{0.3} alloy, are subjected to a pressure of about 200 MPa. Annealing of the N-type thermoelements is identical to the annealing of the P-type thermoelements.

Table 1 below gives the thermoelectric characteristics (electrical conductivity σ and Seebeck coefficient S) of the thermoelements, measured before and after sintering.

Before the sintering step, the power factor σ·S² is equal to 5.1*10⁻² μW·cm⁻¹·K⁻¹ for the P-type thermoelements and to 5.88*10⁻⁵ μW·cm⁻¹·K⁻¹ for the N-type thermoelements.

After the sintering step, the power factor is respectively equal to 4.38 μW·cm⁻¹·K⁻¹ and 6.50 μW·cm⁻¹·K⁻¹ for the P-type and N-type thermo-elements. The power factor is therefore considerably increased by means of the sintering step, in particular in the case of N-type thermoelements subjected to a pressure of 200 MPa.

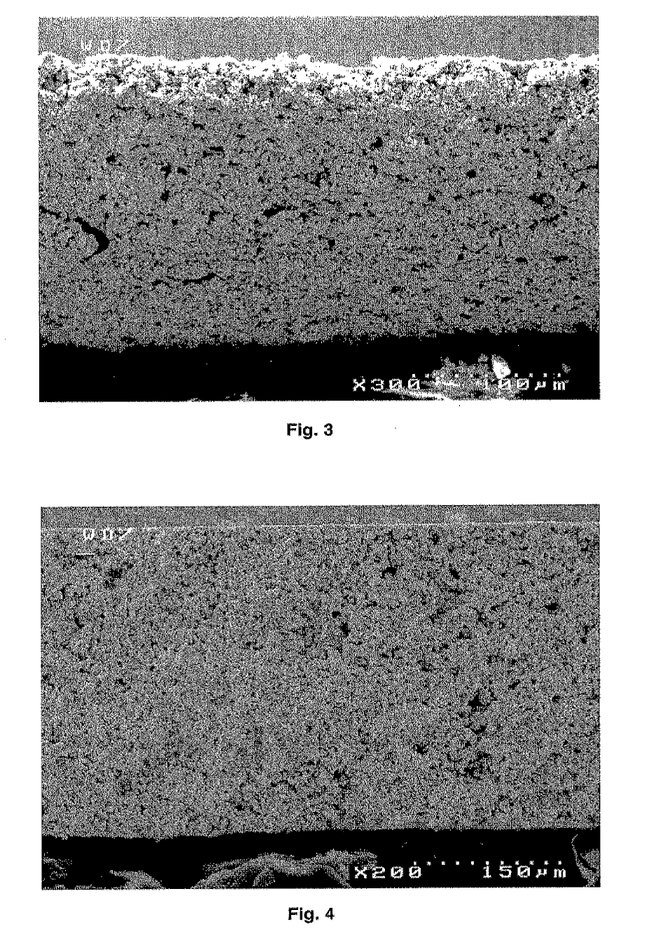

FIGS. 3 and 4 respectively show a thermoelectric layer with a thickness of 60 μm obtained by screen printing and a layer of the same thickness obtained by spraying.

The layers were observed under a scanning electron microscope after the sintering step. As the layer obtained by screen printing (FIG. 3) did not adhere to the polyimide substrate, the layer was turned and stuck onto another substrate to be observed. The portion of the layer in contact with the polyimide substrate is therefore at the top in FIG. 3.

The presence of cracks or fissures can be observed in the layer printed by screen printing. These defects arise from evaporation of the solvent during the heating step. The layer further presents a variable density according to the thickness of the layer. The top portion (in contact with the polyimide) is less dense than the rest of the layer. This low density prevents adhesion on the polyimide substrate.

On the other hand, it is observed that the layer deposited by spraying is devoid of structural defects, for example cracks, and that the density of the layer is globally homogeneous. The thermoelements formed in this way adhere perfectly to the polyimide substrate.

Under certain conditions, the spray printing technique therefore enables a reliable and high-performance module with thermoelectric layers of optimized thickness to be obtained. Even if the performances obtained remain inferior to those of thermoelements produced using the bulk technology (from 35 μW·cm⁻¹·K⁻¹ to 40 μW·cm⁻¹·K⁻¹ for the same materials), they are particularly interesting when the aspects of cost and simplicity of the method are taken into consideration.

Numerous variants and modifications of the method for producing thermoelectric layers will become apparent to the person skilled in the art. In particular, other thermoelectric materials can be used, in particular Zn₄Sb₃. Deposition of layers into cavities formed in a substrate rather than on a flat support could also be envisaged in order to achieve three-dimensional modules.

1. A method for producing a layer of thermoelectric material having a thickness comprised between 50 mm and 500 mm on a substrate, comprising the following steps:
preparing an ink comprising the thermoelectric material, a binding polymer material and a solvent;
depositing a layer of ink on the substrate by pressurized spraying under conditions such that the solvent is partially evaporated before reaching the substrate;
heating the layer of ink to evaporate the solvent;
compressing the layer; and
performing heat treatment to eliminate the binding polymer material.

2. The method according to claim 1, wherein the conditions are such that the quantity of solvent evaporated when deposition of the layer of ink is performed is comprised between 70% and 90%.

3. The method according to claim 1, wherein the ink comprises toluene or polyglycol-methyl-ether acetate, in which particles of thermoelectric material having a diameter comprised between 10 nm and 10 mm are dispersed, and in which polystyrene is dissolved.

4. The method according to claim 1, wherein the weight percentage of thermoelectric material in the ink is comprised between 62% and 74%, the weight percentage of polymer is comprised between 1% and 3% and the weight percentage of solvent is comprised between 25% and 35%.

5. The method according to claim 1, wherein the ink is heated to a temperature strictly lower than the boiling temperature of the solvent during deposition of the layer of ink.

6. The method according to claim 5, wherein the substrate is heated during deposition of the layer of ink.

7. The method according to claim 6, wherein, the solvent being toluene, the substrate is heated to a temperature comprised between 20° C. and 50° C.

8. The method according to claim 6, wherein, the solvent being polyglycol-methyl-ether acetate, the substrate is heated to a temperature comprised between 90° C. and 12° C.

9. The method according to claim 1, wherein the ink is projected onto the substrate by a nozzle with a diameter of more than 400 mm, located at a distance from the substrate comprised between 5 cm and 10 cm by means of a gas under a pressure comprised between 0.8*105 Pa and 105 Pa.

10. The method according to claim 1, wherein the layer of ink is heated to a temperature comprised between 90° C. and 150° C.

11. The method according to claim 1, wherein the layer is compressed at a pressure comprised between 50 MPa and 200 MPa.

12. The method according to claim 1, wherein, the thermoelectric material being a bismuth and tellurium based alloy, the heat treatment is performed at a temperature comprised between 350° C. and 400° C.

13. The method according to claim 1, wherein the substrate is made from polyimide.

14. The method according to claim 1, wherein deposition of the layer of ink is performed by ultrasonic spray deposition.
